(19) United States
(12) Patent Application Publication
(10) Pub. No.: US 2003/0098579 A1
(43) Pub. Date: May 29, 2003

(54) Portable media for confidential information

(76) Inventor: Bertrand Speyer, Auriol (FR)

Correspondence Address: BURNS DOANE SWECKER & MATHIS L L P, POST OFFICE BOX 1404, ALEXANDRIA, VA, 22313-1404, US

(21) Appl. No.: 10/275,081

(22) PCT Filed: May 7, 2001
(86) PCT No.: PCT/FR01/01385

(30) Foreign Application Priority Data
May 10, 2000 (FR) 00/06319

(51) Int. Cl. B42D 15/00

(52) U.S. Cl. 283/106

(57) ABSTRACT

A product forming a portable media for confidential information includes at least two multilayer films. Each film contains at least a sealing layer and at least an opaque layer. The product is assembled by sealing the sealing layers together on their periphery to form a wallet. The confidential information is printed on the sealable inner surface of at least one of the films forming the wallet. The invention is applicable, in particular, to prepaid telephone tickets/cards.

The present invention concerns the field of the supply of confidential information on a physical medium, particularly to allow secure access to prepaid services, in particular in the so-called prepaid telephone sector, or for the lottery.

The invention thus concerns products, such as cards, tickets or other physical media, designed to carry at least one item of confidential information, which must be accessible only to the acquirer or the final addressee of the said products for secure access to prepaid services.

The invention is described below, in order to simplify, with reference to prepaid telephony services. Persons skilled in the art will understand however that it can also be applied to other usages, in particular in the field of secure access to prepaid services, as well as in other fields such as lottery tickets.

It is known how to mask confidential information carried by a document for its secure transmission to its destination. Thus it is known how to produce confidential documents in which the information to be made decipherable only by the user is scrambled or masked by superimposition with appropriate materials, different from and/or complementary to the material carrying the said information. The confidential information is then revealed by a complete or partial removal of the covering material, or by scraping off the layer of covering material. All these techniques are however expensive, since they are relatively complex to implement, because they require several steps. In addition, they have weak points, that is to say operating sequences during which it is possible to read the information which will be integrated in the document, so as no longer to be identifiable, only in a subsequent phase of production of the product.

In the field of prepaid telephone services, there are at the present time products for supplying confidential numbers, in particular so-called HRN numbers, composed of a cardboard or plastic medium, provided with a scratch pad. There also exist products in the form of a more or less opaque envelope containing a sheet bearing the confidential information, the said sheet being provided with a scratch pad and introduced into the envelope. For producing such a scratch pad, the medium concerned is printed with confidential information and this is covered with a scratchable opaque layer.

The tickets/cards currently being manufactured according to these methods are then possibly inserted in a transparent packaging film or skin, and sealed, which constitutes a second level of tamper resistance.

However, self-adhesive scratch pads and packaging film are found on open sale on the market. Consequently, when the points of sale of such scratch tickets/cards are not sufficiently secure/controlled, which is the case in many countries, cards read and then reconditioned, that is to say provided with an adhesive pad in replacement for the scratched pad and a new packaging film, can be put on sale again. Such falsified products then give rise to claims and requests for reimbursement, which have repercussions right back to the original supplier.

In addition, during the manufacture of traditional media for the supply of confidential information, the said information can in some cases be visible to the manufacturing operators, between the marking operation and the operation of masking the printed information. If it is then sought to perform these operations in a “black box”, the manufacture is most generally carried out card by card and is therefore slow and expensive. In addition, some cards thus manufactured may be destroyed or damaged during packaging in flexible film, and their replacement in a manufacturing series also constitutes a slow and expensive process.

There therefore existed a need for information media which are:

secure, through the impossibility of putting the card or ticket back in its initial state, once the revealed information has been read,

such that it is not possible to read the confidential information between its writing and its covering with a scratch panel or any other cladding,

quick to produce,

obtained so that production rejects can be processed immediately at the end of production, that is to say do not require any resumption of a previous operation.

A portable confidential information medium has now been produced, arranged for the supply of access to prepaid services, making it possible to dispense with these drawbacks.

This objective, as well as others which will emerge from a reading of the following description, are achieved by the product according to the invention, which is composed of a wallet formed from a multilayer flexible material, opaque and sealable, in which the confidential information is printed on at least one of the internal faces of the said wallet and can be read after tearing and/or cutting the wallet.

The invention proposes for this purpose a product forming a portable confidential information medium, containing the confidential information on an internal part of a tearable closed medium, which comprises at least two multilayer films, each of which comprises at least sealing layer and at least one opaque layer. These films are joined by sealing the sealing layers together at their periphery in order to form a wallet. The confidential information is printed on the internal face of at least one of the films forming the said wallet, this being able to be cut and/or torn at least over part of its periphery and/or on at least one of its faces, in order to make the confidential information accessible.

It is advantageous for the said sealable material to be able to be sealed on any part of its surface, to make it possible to vary the shape of the said medium as required.

The wallet according to the invention can also preferably comprise product personalisation elements, such as a logo, a face value or others, on at least one of its external and/or internal faces.

Another object of the invention is a method, as defined below, for obtaining such a product.

The expression “confidential information” designates here essentially confidential numbers for prepaid telephone services, to which access is reserved for calls preceded by such a confidential number. Commonly such a number is called an “HRN” number. In practice, this information could however comprise figures and/or letters, without departing from the scope of the present invention.

“Opaque” material means here a material able to form a barrier to light radiation having a wavelength of between approximately 500 and 900 nm, and more particularly a material having, vis-à-vis such a light radiation, a total opacity greater than 2.5. Total opacity is considered here to be that of all the layers and/or flaps of the wallet formed by films of the above mentioned multilayer material.

In a multilayer material in the sense meant here, one or more of the layers constituting the multilayer material may be a film.

The measurement of the transmission, equal to the percentage of the initial light flux which passes through the material whose opacity is to be evaluated for a given wavelength, gives the opacity by the equation:

Opacity=Log(1/Transmission).

The opacity is thus a quantity without unit of measurement. Below 2, it is considered here that the opacity is insufficient. An opacity of 2.5 means an opaque material in the sense meant here. Complete opacity corresponds to an opacity factor of approximately 3.2.

The term “sealable” means here the suitability of a material for being sealed on itself or on another identical or different material by means of a traditional sealing operation, with the addition of external energy, in particular by hot sealing, ultrasonic or pressure sealing or any other appropriate sealing technique compatible with the, material concerned. A sealable material may be sealed without the addition of external material. The sealing of the material with itself or with another may however also be effected, but less advantageously economically, with the addition of an intermediate material, such as an adhesive material, a double-face adhesive, a heat activated adhesive or the like.

The expression “sealed on their periphery” means here that the films and materials constituting the wallet are sealed by means of an appropriate traditional method along peripheral or substantially peripheral lines. Thus the sealing can strictly follow this periphery, or be some distance away from it. The sealing may even, in a variant, leave over the whole or preferably part of this periphery a projecting part of at least one of the two films of material forming the wallet, this projecting part then being able to constitute a gripping and/or attachment lug, if so required.

Other characteristics and advantages of the present invention will emerge from a reading of the detailed description which follows, with reference to the accompanying figures, in which:

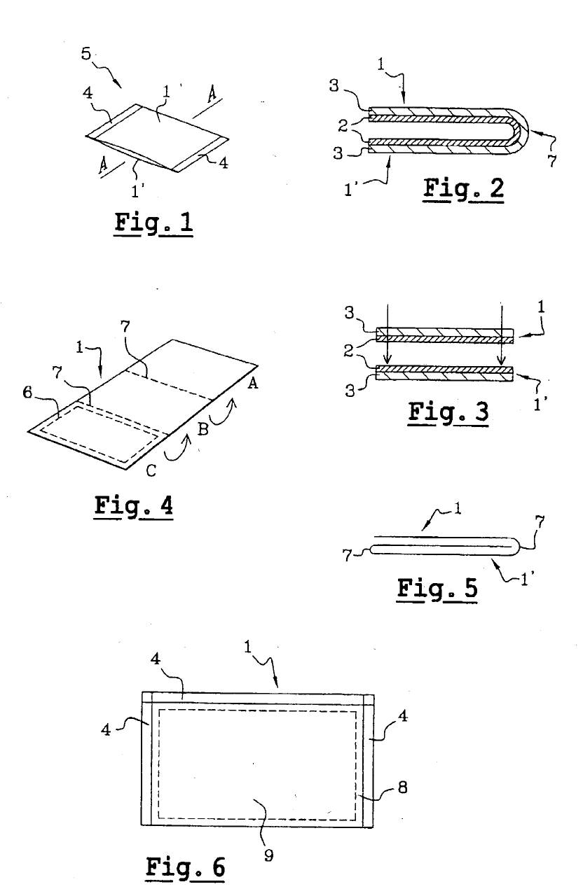

FIG. 1 depicts schematically a plan view in perspective, after presealing on two sides, of a product according to the invention,

FIG. 2 is a view in schematic transverse section along A-A of the product in accordance with FIG. 1,

FIG. 3 depicts a view in schematic transverse section of films for obtaining a variant of the wallet according to the invention,

FIG. 4 depicts schematically a plan view in perspective of an area of sheet or strip of material for obtaining another variant of the wallet according to the invention,

FIG. 5 is a view in schematic transverse section of the variant of the product according to the invention according to FIG. 4, before sealing, and

FIG. 6 is a plan view of an embodiment of a product according to the invention, after complete peripheral sealing.

In its preferred embodiment, depicted in FIGS. 1 and 2, a wallet according to the invention consists of two twin-layer films (1, 1′), each of which is composed of a sealable layer (2) and an opaque layer (3), these two films being sealed together along sealing lines (4) in order to form a closed wallet (5).

For manufacturing such a wallet on an industrial scale, a strip of appropriate multilayer material is brought opposite print heads (not shown) which, by means of suitable marking on the strip, print on predefined areas of said strip confidential information, which can then be covered with pull-off masking, if so required, and, optionally, other information, not confidential, on only one face or on both faces of the strip. During its movement, the said strip is then folded along a longitudinal median line 7, with respect to the direction of movement of the strip. In practice, the direction of the folding must be such that it brings the face of the material composed of a sealable layer towards the inside of the fold, so as to allow the sealing of the periphery of the printed areas of the strip thus folded. The printed confidential information contained in the wallet is then sheltered from sight and protected from falsification.

The preferred strip material is a multilayer complex, commercially available and conventionally used in the food industry, in particular for the capping and/or packaging of liquid food products, such as milk products or fruit juices. Such a complex or composite material has, in its most simple embodiment, a twin-layer structure, composed of a layer of synthetic thermoplastic material, in particular polyethylene (PE) and/or a copolymer of EAA, and a metallic layer, in particular a layer of metal such as aluminium or a layer of carbon or suitable dye. As a variant, the material can have other layers, such as for example a layer of paper or another suitable light-coloured material to facilitate printing on the corresponding face of the sheet or strip composed of such a complex material having at least the above mentioned three layers. A material of this type is a product sold under the name “layered complex”, bearing a trade name composed of: thickness in g/Alu/PE (technical definition+thickness).

When it is wished to introduce liquids and/or gases into the product forming the wallet according to the invention, it is advantageous for the material of the wallet itself to be impervious to liquids and/or gases, which can be achieved with one or more layers of an appropriate thermoplastic material, in particular polyethylene and/or EAA copolymer.

A thickness of the said material in sheet or strip form for producing the above mentioned films may, by way of non-limiting example, be approximately 80 to 150 m.

In the embodiment depicted in FIG. 3, the above mentioned films (1, 1′) are each formed from a different strip. The two strips concerned, moving parallel after their respective printings in a similar manner to what is indicated above, are brought facing each other and applied against each other, on the side of their sealable faces. A sealing energy is then applied (with pressure in the direction of the arrows in FIG. 3) in order to effect the sealing of the wallet, over all or part of its predefined periphery.

In another embodiment, depicted schematically in transverse section in FIGS. 4-5, the product according to the invention is made from a flexible sheet or strip of a complex material as described above, one of whose faces is printed in suitable fashion, on at least three printing areas, preferably three contiguous areas A, B, C, the first of these areas receiving for example the confidential information to be masked, whilst the second and third areas each receive independently a printing chosen to suit, advantageously a personalisation printing on at least one of these two areas. Advantageously, the printings in the above mentioned three areas are thus effected on the same side of the sheet or strip, and the folding along the folding lines 7 of the predefined areas A, B, C is carried out accordingly, as indicated by the curved arrows in FIG. 4, and then a presealing is effected along the lines 4 in order to give a product presealed along a part of the circumference predefined for the wallet. This product has an internal flat, as can be seen in FIG. 5. The presealing lines follow only part of the periphery, for example n−x of the n sides of the product, at least one side of which is still open at this stage, whilst n is an integer number equal to or greater than 3 and x is an integer number equal to at least 1. It is then possible, as an option, to insert in the product any required element, such as for example promotional objects, in particular solid, liquid and/or gaseous products, before final sealing of the n^{th} side of the said product, which then forms an entirely sealed wallet.

In a variant, the above indications can be applied to a group of several products, manufactured simultaneously, with a common sealing line.

In addition, the product according to the invention can be of any form. In particular, the circumference of the wallet may be produced according to any required form, and any flaps present inside the wallet formed according to the invention (see FIGS. 4-5) can also be of any form and be sealed or not with the films making up the walls of the wallet. It is then no longer a question of sides in the geometric sense of the term and the above presealing is simply arranged to leave free part of the circumference of the product sufficient to allow optional insertion of a predefined element or one chosen to suit, such as for example perfume, a sample of solid product, a small object, or others.

This possibility of infinite variation of the forms of the wallets constitutes an additional advantage of the invention. The fact that the use of a sheet or strip having a layer sealable over all or practically all of the surface of the said sealable film is recommended actually makes it possible to seal wallets of very different shapes without difficulty, without its being necessary to select a particular strip which would have an appropriate profile of a layer of sealable material, and without its being necessary to change strip when it is wished to deal with limited series of wallets with very varied shapes, on a production line.

In all cases, the product in the course of manufacture may have presealing lines over only part of its periphery, whilst the non-sealed part is still open at this stage, to make it possible as an option to insert in the wallet any additional required element, such as for example promotional objects, before complete sealing of the said wallet, which then forms an entirely sealed wallet.

The product forming a portable confidential information medium according to the invention can be opaque over all its surface or only over part thereof, for example on the area or part of the area intended for printing the confidential information.

According to a preferred embodiment, applicable to any one of the above mentioned variants and illustrated in FIG. 6, the product according to the invention, sealed along the lines 4, can also have prescoring 6 and/or 8 (see FIGS. 4 and 6 respectively) intended to make it possible to separate from the said product at least part 9 of at least one of its principal faces. The part 9 thus removed may, for example, make it possible to gain access to the confidential information and/or be useful as a card or ticket, for the applications indicated above.

As an option, and in order to improve still further the security of the product according to the invention, this can also include one or more additional security elements, such as for example an antenna wire.

Another object of the invention is a method for producing the product according to the present invention.

The said method includes the sealing, at least along the periphery of a predefined contour, of at least two multilayer films. The films are chosen so that each of them has at least one sealing layer and at least one opaque layer. As for the confidential information, this is printed on one of the sealable faces of at least one of the said multilayer films. The said films are then joined by sealing the sealing layers together in order to form a wallet.

Such a method advantageously includes the steps consisting of:

procuring a sheet or strip of flexible plastics material, opaque over at least the parts of its surface intended to receive confidential information or facing it, and advantageously opaque over its entire surface,

printing on this material respectively at least some of the required printed elements and, at the same time as these elements or subsequently, the said confidential information, on at least two respective areas, or as a variant on the two faces of one and the same area, previously defined on the said medium,

effecting, as an option, on at least one area, a prescoring 6 in order to open the wallet and/or to remove an element therefrom,

folding the sheet or strip along at least one longitudinal folding line 7 separating two contiguous areas,

or as a variant bringing the above mentioned printed sheet or strip closer to a sheet or strip of base material 1′ (see FIG. 3),

optionally printing the printing elements still missing at this stage,

optionally effecting a through score 8, for the opening of the wallet and/or the removal of some of the material concealing the confidential information, such as for example one of the faces of the wallet and/or a strip of any masking, in particular a scratchable strip, and

sealing and cutting over all or some of its periphery 4 the product thus produced, so as to form a wallet 5 or group of wallets 5 entirely closed or, as a variant, still having an opening, and in the latter case, optionally,

introducing solid, liquid and/or gaseous elements into the wallet thus formed, in the case where the said wallet still has an opening, and sealing the said opening.

“Longitudinal folding” means folding along a line parallel to the direction of movement of the strip of material subjected to the method according to the invention.

According to an embodiment preferred from the industrial and economical point of view, the above mentioned film can contain several units of product and the subsequent steps then result in a string of wallets, having a number of units and/or a length which can be chosen to suit, simply by adapting the equipment to do this. The wallets thus produced in strings can then be separated from each other individually or in predefined batches.

The invention thus makes it possible to produce tickets/cards having confidential codes for protecting access to prepaid services, in particular prepaid tickets/cards for telephony or lottery tickets.

The wallet forming a confidential information medium according to the invention can have any shape, which it is easy to obtain using appropriate stamping/welding tools.

In all cases where the contour of the wallets leaves material unused, this is removed and is possibly recycled, according to known techniques.

By procuring for it, during sealing and subsequent cutting, an appropriate projecting part, which can be provided with a through perforation, it is possible to provide the sachet according to the invention with an external gripping member, possibly able to facilitate the start of cutting of the wallet, and/or of a means of attaching it, in particular useful at the point of sale.

To open the product forming a wallet according to the invention, the user cuts or tears at least part of the periphery of the said wallet, and/or tears or cuts it along the above mentioned lines 6 and/or 8, and according to circumstances can keep one or more of the parts thus separated. At least one of the parts of the wallet thus separated (for example the part 9) is advantageously to the ISO format for credit cards, with regard to the width and length of the rectangle, to make its use and storage more practical.

The invention thus makes it possible to obtain a confidential information medium which is secure, both at the production stage and at the transmission stage, until the supply of the confidential information concerned to the final user.

The product and method according to the invention allow production at high efficiency, and therefore at low cost, and, on the same production line, allow the optional insertion in the same medium of promotional samples or other elements attractive to or useful for the purchaser of the said product.

1. A product forming a portable confidential information medium, the said product comprising at least two multilayer films (1, 1′), each of which has at least one sealing layer and at least one opaque layer (3), the said films being joined by sealing (4) the said sealing layers together at their periphery in order to form a wallet (5), characterised in that the said confidential information is printed on the said sealing layer (2).

2. A product according to claim 1, characterised in that the said sealing layer (2) occupies the entire surface of the layer on which the said confidential information is printed.

3. A product according to claims 1 and 2, characterised in that the said confidential information is a number for access to a prepaid telephony service (3).

4. A product according to one of claims 1 to 3, characterised in that the said multilayer film comprises an opaque layer or film (3) conferring on it total opacity greater than 2.5, preferably approximately 3, vis-à-vis light radiation having a wavelength of between approximately 500 and 900 nm.

5. A product according to claims 1 to 4, characterised in that the said film (3) is opaque over all or practically all of its surface.

6. A product according to claim 1, characterised in that the said films are composed of a layer of synthetic thermoplastic material, in particular polyethylene, and a metallic layer, in particular a layer of metal such as aluminium.

7. A product according to claim 6, characterised in that at least one of the said films also comprises another suitable light-coloured material for facilitating printing, in particular of the paper.

8. A product according to any one of claims 1 to 7, characterised in that it comprises two multilayer films, formed from two contiguous areas (A, B) of a sheet or strip brought together by folding along a folding line (7).

9. A product according to any one of claims 1 to 7, characterised in that it comprises two multilayer films, formed respectively from two sheets or strips (6, 6′).

10. A product according to any one of claims 1 to 7, characterised in that it comprises at least two multilayer films, formed from more than two contiguous areas (A, B, C) of a sheet or strip (6), folded on themselves along at least two folding lines (7).

11. A product according to claim 10, characterised in that it comprises at least one internal flap obtained by folding along one of the lines (7) and carrying at least one item of confidential information.

12. A product according to any one of claims 1 to 11, characterised in that the said wallet is able to be cut and/or torn over at least over part of its periphery and/or at least one of its faces, in order to make the confidential information accessible.

13. A product according to any one of claims 1 to 12, characterised in that at least one of the external and/or internal faces of at least one of the films forming the said wallet carries non-confidential information, for example personalisation, in particular a logo and/or a face value.

14. A product according to claim 10, characterised in that it is formed from three contiguous areas (A, B, C) of a flexible sheet or strip (6), the first of these areas receiving the confidential information, whilst the second and third areas receive printing chosen to suit, advantageously personalisation printing on at least one of these two areas, and the three areas (A, B, C) being folded on one another along the folding lines (7) so that the confidential information is situated on a flap internal to the wallet obtained after sealing of the areas (B), (C) and possibly (A) on their periphery.

15. A method of manufacturing a product forming a portable confidential information medium, the said product comprising at least two multilayer films (1, 1′), each of which comprises at least one sealing layer (2) and at least one opaque layer (3), joined by sealing (4) the said sealing layers together on their periphery in order to form a wallet (5), characterised in that it consists of printing the said confidential information on the said sealing layer (2).
